(19) United States
(12) Patent Application Publication
(10) Pub. No.: US 2019/0389574 A1
(43) Pub. Date: Dec. 26, 2019

(54) HANG GLIDER WITH ELECTRIC FAN MOTOR

(71) Applicant: CAMELLIO GONZALES, SENTINEL, OK (US)

(72) Inventor: CAMELLIO GONZALES, SENTINEL, OK (US)

(21) Appl. No.: 16/014,022

(22) Filed: Jun. 21, 2018

(51) Int. Cl. B64C 31/032; B64D 27/24; B64D 31/04; B64D 43/00

(52) U.S. Cl. CPC B64C 31/032; B64D 43/00; B64D 31/04; B64D 27/24

(57) ABSTRACT

The present invention relates to a hang glider coupled to electric fan motor for providing thrust while flying and thus providing extra safety to the hang glider. Herein, the electric fan motor of hang glider consists of rechargeable batteries which get charged either through solar panels or get charged kinetically. The electric fan motors coupled at various positions of hang glider and controlled by the throttles, provides proper thrust to the hang glide to move and the rechargeable batteries of the electric fan motor enables the glider to soar continuously for many hours.

### FIELD OF THE INVENTION

The present invention generally relates to a hang glider coupled to electric fan motors for providing thrust while flying and thus providing extra safety to the hang glider.

### BACKGROUND OF THE INVENTION

Hang gliding is an air sport or a recreational activity in which a pilot flies a light, non-motorized foot-launched aircraft called a hang glider. Early hang gliders had a low lift-to-drag ratio, so pilots were restricted to gliding down small hills.

Conventionally, the hang glider requires the pilot to make an approach run to catch an updraft or to leap down from a high place. Therefore, it is necessary to find a location with a difference in altitude between the taking off point and the landing point and even if the take off by way of an approach run is successful, it is difficult to soar continuously for many hours.

To overcome the above-mentioned problem, the hang gliders are now equipped with electric motor which is attached to the hang glider for providing the glider a motion. Presently, there are several prior arts available which provide electric motor fans attached to the hang gliders.

A major draw-back for the present scenario hang gliders are that electric motors herein lack's good durability and long duration operational capability for the hang gliders. Also, the batteries supporting the electric fans of the hang gliders are further not provided with a power source for self-recharging.

### SUMMARY OF THE INVENTION

The main objective of the present invention is to overcome the limitations of the prior arts by providing a hang glider coupled to electric fan motors for providing thrust while flying and thus providing extra safety to the hang glider.

The present invention provides a hang glider comprising at least one electric fan motor, coupled between the leading edge and the cross-tube; at least one electric fan motor coupled to the tail; at least one electric fan motor coupled to proximal end of the kneel pole and at least one electric fan motor coupled to the distal end of the kneel pole. The control bar of the hang glider is coupled to at least one throttle, wherein the at least one throttle controls the function of at least one electric fan motor and enable the glider to soar for long time with safety. Each electric fan motor is coupled with rechargeable battery which are enabled to be charged by a generator of kinetic energy which convert the kinetic energy of the at least one electric fan motor into the electrical energy for charging the at least one rechargeable battery of the its electric fan motor. Herein, the electric fan motor coupled to the tail of the hang glider enables to provide appropriate thrust at the time of lifting of the hang glider and the electric fan motor coupled to leading edge and the kneel pole enables the hang glider to soar for long time. The control bar is further coupled to the battery indicator for indicating the status of each rechargeable battery of each electric fan motor for analyzing the safety landing on time.

In other embodiment, the canopy of the hang glider is coupled with the solar panels for charging the at least one rechargeable battery of at least one electric fan motor.

### BRIEF DESCRIPTION OF THE DRAWINGS

The following drawings illustrates exemplary embodiment; however, they are helpful in illustrating objects, features and advantages of the present invention because the present invention will be more apparent from the following detailed description taken in conjunction with accompanying drawings in which:

FIG. 1 illustrates the top view of the given invention.

FIG. 2 illustrates the top view of the control bar of the given invention.

### DETAILED DESCRIPTION OF THE INVENTION

Reference will now be made in detail to the exemplary embodiment (s) of the invention, examples of which are illustrated in the accompanying drawings. Whenever possible, the same reference numerals will be used throughout the drawings to refer to the same or like parts.

References to “one embodiment,” “at least one embodiment,” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

The present invention relates to a hang glider coupled to electric fan motor for providing thrust while flying and thus providing extra safety to the hang glider. Herein, the electric fan motor of hang glider consists of rechargeable batteries which get charged either through solar panels or get charged kinetically. The electric fan motors coupled at various positions of hang glider and controlled by the throttles, provides proper thrust to the hang glide to move and the rechargeable batteries of the electric fan motor enables the glider to soar continuously for many hours.

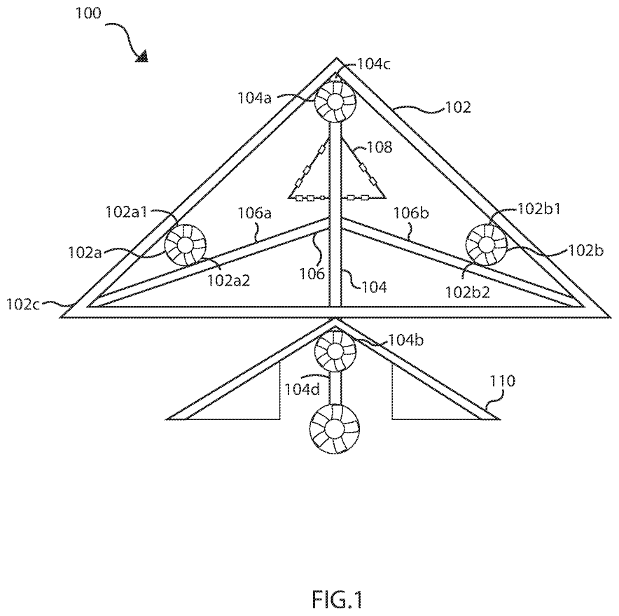

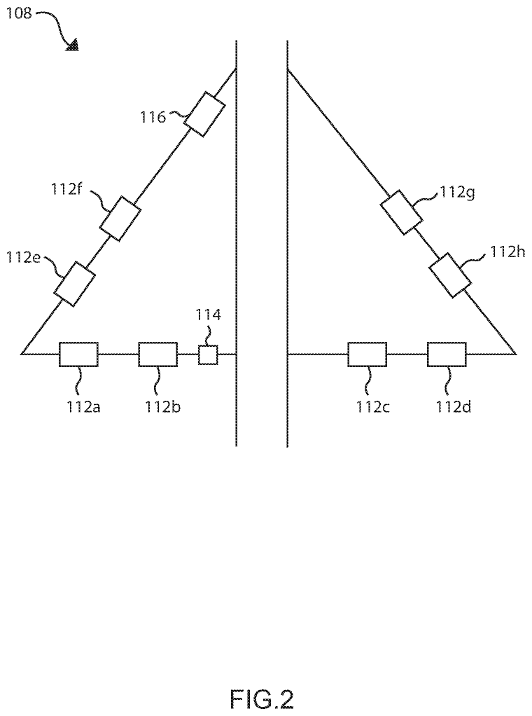

FIG. 1 and FIG. 2 which are also the preferred embodiment of the invention are as follows:

FIG. 1 illustrates the top view of the given invention according to an embodiment of the invention. Conventional hang glider (100) comprises a leading edge (102) coupled to a kneel pole (104), a cross-tube (106) and a control bar (108) and the kneel pole (104) is further coupled to a tail (110). This assembly of the hang glider (100) is further covered by a canopy (not shown). In the present invention, the at least one electric fan motor is coupled to the conventional hang glider (100) as follows:

a. The kneel pole (104) is coupled to at least one electric fan motor (104a) at its proximal end (104c) and is further coupled to at least one electric fan motor (104b) at its distal end (104d).
b. Another at least one electric fan motor (102a) is coupled to the left side of the leading edge (102c) such that first portion (102a1) of the at least one electric fan motor (102a) is coupled to the leading edge (102) and a second portion (102a2) of the at least one electric fan motor (102a) is coupled to the left side of the cross-tube (106a).
c. Another at least one electric fan motor (102b) is coupled to the right side of the leading edge (102d) such that first portion (102b1) of the at least one electric fan motor (102b) is coupled to the leading edge (102) and a second portion (102b2) of the at least one electric fan motor (102b) is coupled to the right-side of the cross-tube (106b).
d. Yet another at least one electric fan motor (110a) is couple to the tail (110) of the hang glider (100).
The control bar (108) further comprises at least one throttle (112) to couple to at least one electric fan motor.

Herein, the canopy of the present invention is made up of light weight material such as but not limited to synthetic or nylon sail. The material for assembly of hang glider (100) (kneel pole, leading edge, cross-tube, control bar and tail) is also light weight material such as but not limited to aluminum, steel or metal alloy. The at least one electric fan motor is further coupled with fan blade made up of material such as but not limited to plastic, a wood or an alloy metal. Due to the light weight material the hang glider is easy to soar. Herein, each electric fan motor is further coupled to the generator (not shown) of kinetic energy which is enabled to convert the kinetic energy of the at least one electric fan motor into the electrical energy for charging the at least one rechargeable battery.

FIG. 2 illustrates the top view of the control bar (108) of the given invention. The control bar (108) further comprises at least one throttle (112) to couple to at least one electric fan motor, wherein arrangement of at least one throttle (112) with at least one electric fan motor is as follows:

Throttle (112a) electronically couples to at least one electric fan motor (102a),

Throttle (112b) electronically couples to at least one electric fan motor (104a),

Throttle (112c) electronically couples to at least one electric fan motor (104b),

Throttle (112d) electronically couples to at least one electric fan motor (102b),

Throttle (112e) electronically couples to at least one electric fan motor (102a),

Throttle (112f) electronically couples to at least one electric fan motor (104a),

Throttle (112g) electronically couples to at least one electric fan motor (104b) and

Throttle (112h) electronically couples to at least one electric fan motor (102b).

The control bar (108) is further coupled with toggle switch (114) which controls all the throttles (112) at the same time for providing appropriate thrust to the hang glider (100) at the time of take-off. Also, the control bar (108) is equipped with a battery indicator (116) coupled to each rechargeable battery which notifies the glider about the status of each rechargeable batteries of the at least one electric fan motor which enables the glider to analyze his/her proper landing time.

In other embodiment, the at least one electric fan motor is made up of water proof material or is covered by a water proof cover coupled to the assembly (kneel pole, leading edge, cross-tube, control bar and tail) and to the at least one electric fan motor for preventing any damage from water in case of sudden rain or accidental crashing in a water body

In another embodiment, the canopy of the hang glider is coupled to a solar panel which is further coupled to each electric motor for charging the at least one rechargeable battery of each electric motor.

Although the invention has been explained in relation to its preferred embodiment, it is to be understood that many other possible modifications and variation scan be made without departing from the spirit and scope of the invention.

What is claimed is:

1. A hang glider comprising:
at least one electric fan motor coupled to each of:
a proximal end and a distal end of a kneel pole,
between a leading edge and a cross-tube;
a tail; and
at least one throttle coupled to a control bar for controlling the at least one electric fan motor.

2. The hang glider of claim 1, wherein the at least one electric fan motor further comprises at least one rechargeable battery.

3. The hang glider of claim 1, wherein a canopy of the hang glider is coupled to at least one flexible solar panel for recharging the at least one rechargeable battery of the at least one electric fan motor.

4. The hang glider of claim 1, wherein the at least one electric fan motor is covered by a water proof casing.

5. The hang glider of claim 1, wherein the at least one electric fan motor is made up of water proof material.

6. The hang glider of claim 1, wherein the at least one electric fan motor is further coupled to a generator of kinetic energy for converting the kinetic energy of the fan blade into the electric energy of the at least one rechargeable battery.

7. The hang glider of claim 1, wherein the control bar is further coupled to a toggle switch for controlling all throttles at a time.

8. The hang glider of claim 1, wherein the control bar is further coupled to a battery indicator for indicating a status of the at least one rechargeable battery.
